(19) United States
(12) Patent Application Publication
(10) Pub. No.: US 2017/0055146 A1
(43) Pub. Date: Feb. 23, 2017

(54) USER AUTHENTICATION AND/OR ONLINE PAYMENT USING NEAR WIRELESS COMMUNICATION WITH A HOST COMPUTER

(71) Applicant: Hajoon Ko, Bundang (KR)

(72) Inventor: Hajoon Ko, Bundang (KR)

(21) Appl. No.: 15/006,280

(22) Filed: Jan. 26, 2016

(30) Foreign Application Priority Data
Aug. 19, 2015 (KR) 10-2015-0116491
Nov. 11, 2015 (KR) 10-2015-0156368

(51) Int. Cl. H04W 12/02; H04W 12/06; H04L 29/06

(52) U.S. Cl. CPC H04W 12/02; H04L 63/0861; H04L 63/0807; H04L 63/0853; H04L 63/0492; H04W 12/06

(57) ABSTRACT

A system and computer-implemented method for authenticating a user of a host computer communicating with a service server over a network. A mobile communication device including at least one processor and enabled for near field communication (NFC) receives authentication event information from the host computer via a near field communication link, wherein the authentication event information was generated by the service server and uniquely identifies a particular service process between the service server and host computer. At least one processor of the mobile communication device transmits authentication data associated with the user and the received authentication event information to an authentication server that is physically separate from the service server. The transmitted authentication data and authentication event information permit the authentication server to authenticate the user and notify the service server of the authentication results.

### FIELD

This disclosure relates generally to biometric authentication, and more particularly, to user biometric authentication and/or online payment based on near field communication (NFC) between a host computer device and a user's mobile device.

### BACKGROUND

Today, people use various online payment transactions and online authentications. In general, when they use personal computers, they run a web browser to connect to their target website, which website then performs a series of steps for authentication. The most critical issue here is security against malicious cyber attacks. If attacks are successful, the user may lose not only his personal information, but also other sensitive data such as credit card numbers and passwords.

Where user personal information and sensitive information is stored on the user's own computer (host computer), various countermeasures exist that attempt to diminish the risk of cyber attacks. One such countermeasure is to install specialized security software modules on the user's host computer to prevent attacks during authentication or payment procedures at the user's end. Such countermeasures, however, cause considerable inconvenience to users. For example, as consumers or users are likely to connect to various websites, they generally have to install security software modules for each website they visit. To maintain a high level of security, users also have to update their installed software regularly. Moreover, some malware may exploit these types of specialized security module countermeasures by pretending to be security software and deceiving an unwitting user or consumer into installing malicious software on the user's host computer. The core problem for all of these is that the user's sensitive data is stored on the host computer.

In some authentication systems, such as Amazon's 1-Click® technology described in U.S. Pat. Nos. 5,960,411 and 8,341,036 B2, the user does not store personal sensitive data in the host computer, but rather the user's sensitive data is stored in an authentication server. Once the server receives from the user the minimum authentication token to authenticate that user, the server loads the user's sensitive data previously stored in the server's database. Examples of the user's authentication token may include (but are not limited to) ID, password, cookie, etc. Examples of the user's sensitive data include (but are not limited to) credit card numbers.

This technology is more convenient for the user since the user need not install security software in the host computer and there are no complex procedures for authentication. The user only needs to type in the user's authentication token in order to authenticate the user and make payment. However, such a mechanism shifts the security burden from the user to the service provider, who has to protect its system against attackers. As there is always risk of security breach, the service provider has to put an enormous effort on securing its system and diligently upgrade its security framework. Meanwhile, the user still needs to type in his credit card information whenever he visits and registers to a new website, and the user also has to remember his authentication token for each website.

In some other systems, a special hardware token distinct from the host computer device is used for enhancing authentication, such as One Time Password (OTP) devices. Other approaches use a dynamic authentication code sent to the user's mobile device via, for example, a text message over a wireless/cellular communication network. Both of these approaches require the user to type in either the user's OTP or dynamic authentication code on the host computer's screen. In either case, the service server has to maintain its own database to store each of its clients' unique secret (private) data for secure user authentication. Thus, the service server can be exposed to malicious attacks. As a countermeasure, the service server has forced users to install various security modules on their host computer device, which tends to deteriorate user convenience while using the host computer device.

Storing private user data in the host computer requires the user to fully trust the host computer they are using and necessitates the installation of various security modules on the host computer. Storing user's private data in the service server gives great burden and responsibility to the service provider. Furthermore, the user is still required to reveal private data to the service server and has to remember the user's authentication token in order to use it.

### SUMMARY

Users of service provider websites and the providers themselves, therefore, have a need for improved payment and authentication technology that maintains or improves the user experience while also improving security and reducing the risks associated with storing personal and sensitive data. As described herein, various embodiments of the payment and authentication system and method provide technical solutions to the problems, including by, inter alia: (1) isolating the authentication process (e.g., confirming the user is authorized) from the process of delivering services (e.g., providing shopping or banking services); (2) removing the need to store and transfer personal and sensitive data on and between the user's host computer and many service providers; and (3) enhancing authentication by using a biometrically equipped mobile communication device (e.g., smartphone) in the authentication process.

Specifically, one aspect of the system and method shifts the traditional authentication process between the user's host computer and service provider's service server, to communications between a mobile communication device and an authentication server. In this aspect, when a user's engagement with a service provider requires that the service provider authenticate the user, the service server does not attempt to authenticate the user, but instead sends authentication event information to the user's host computer. The user's host computer, in turn, communicates this authentication event information message to the user's mobile communication device (e.g., smart phone) via near field communications (NFC) or some other wireless communication link. This, in turn, initiates an authentication process between the mobile communication device and an authentication server. Namely, once the authentication request is transferred to the mobile communication device, the mobile communication device retrieves authentication data (e.g., user ID, password, etc.) stored on the device and/or generates authentication data (e.g., biometric data) from the user's biometric object (e.g., finger, iris, etc.). The mobile communication device then transmits the authentication data and authentication event information to a dedicated authentication server, either directly via a cellular network or indirectly using the host computer and/or service server as a router. If authentication is successful, the authentication server notifies the service server that the user is authentic (i.e., the user is who he says he is). The service server may then confirm to the user's host computer whether the authentication succeeded or failed.

In some aspects of the system and method, biometric data may be used in conjunction with the mobile communication device to generate authentication data and/or unlock personal and sensitive information. In one aspect, the user registers a hashed value of his biometric data with an authentication server. On later authentication requests from a service server, the user's mobile communication device scans the user's biometric object, generates a hashed value and transmits it to the authentication server. The authentication server then compares the hashed value received to the stored reference value for the user in its database. The authentication server then notifies the service server whether the authentication succeeded or failed.

In a second aspect of the biometric authentication, all personal and sensitive information (e.g., authentication data) is encrypted using the user's biometric data and stored in the user's mobile communication device. In this aspect, when authentication event information is received, the user's biometric object is scanned and used to decrypt the authentication data. The decrypted authentication data is then sent to the authentication server, which, in turn, notifies the service server whether the authentication succeeded or failed.

In a third alternate aspect of the biometric authentication, the user's mobile communication device includes a dedicated security module or crypto-processor. In this aspect, the crypto-processor stores the personal and sensitive information (e.g., authentication data) that can only be accessed through biometric authentication. The processor can also be configured to only communicate with specified software modules on the mobile communication device that will, in turn, communicate user authentication data and authentication event information to the authentication server.

In all of these aspects, the user's original biometric data is stored only in the user's mobile communication device and not in the authentication server, service server or host computer. Thus, the user's biometric data is protected from digital theft by either cryptographic technique or hardware security. Similarly, the user's personal and sensitive data is stored only in encrypted form in the user's mobile communication device or in the authentication server and not in the host computer or service server. Thus, even if the user loses his device, a third party maliciously launches attacks, or the authentication server's database gets physically stolen or digitally compromised, the user's original biometric data, and personal and sensitive information will not be exposed or otherwise compromised.

Using the foregoing aspects, the service process (e.g., the interaction between the user's host computer and a service server) is completely isolated from the authentication process. Thus, the service provider can fully focus on tuning its system to providing the best service. That is, the service provider does not take on any of the burden of securing its users' personal and sensitive data used for authentication or payment. This separation also provides great benefit to users. For example, whenever a user connects to a new service provider's system, the user need not install a new security module on the user's device, nor does the user need to provide sensitive private data to the service provider, such as (but not limited to) the user's credit card number(s). This is possible because the authentication process (e.g., payment) is completely isolated from the service process (e.g., shopping) and all authentication data (e.g., user ID, password, credit card information, etc.) is maintained on the user's mobile communication device or the authentication server. This mechanism requires much less systematic effort for counteracting malicious attacks on the host computer device or the service server.

Using the system and methods disclosed herein, a user can shop online or engage in banking transactions using any available (trusted or untrusted) desktop/laptop computer, because all sensitive authentication data are processed by the end-to-end encrypted data transfer between the user's mobile communication device and an authentication server. Thus, even if the host computer is an untrusted device (e.g., it does not belong to the user), the user can be reassured that the user's sensitive authentication data will remain secure regardless of potential compromise of the host computer.

These advantages become even more attractive when the host computer device is an Internet of Things (IoT) device. In general, security of resource-constrained IoT devices is a difficult problem. Isolating the host and service computers, however, allows the user to authenticate himself or make mobile payment through any (untrusted) IoT device by using the user's mobile communication device to link to the IoT device and authenticate with an authentication server (i.e., not passing personal and sensitive data through the IoT device).

The benefits and advantages of the system and method disclosed herein have many uses, including, ecommerce, financial, and commercial or governmental service websites, and to approve a user to log into a server, to commit online payment or wire transfer, or issue digital legal certificates such as a family certificate or marriage certificate. Overall these aspects and others described below provide a complete and secure user authentication and payment system and method that is useful for a wide range of commercial or administrative applications.

### BRIEF DESCRIPTION OF THE DRAWINGS

The accompanying drawings illustrate various non-limiting, example, innovative aspects in accordance with the present descriptions:

FIG. 1 is a high level block diagram illustrating one embodiment of the authentication system;

FIG. 2 is a block diagram of one embodiment of the authentication system using communication from a mobile communication device to an authentication server via a wireless network;

FIG. 3 is a block diagram of an alternate embodiment of the authentication system using communication from a mobile communication device to an authentication sever via the host computer and service server;

FIG. 4 is a block diagram of yet another embodiment of the authentication system using the host computer to communicate with the authentication server;

FIG. 5 is an illustration of the representative architecture and interface layers of an embodiment of the authentication system;

FIG. 6 shows exemplary embodiments of host computers that may be employed in the authentication system;

FIG. 7 shows exemplary embodiments of biometric authentication that may be employed on a wireless communication device;

FIG. 8 shows the communication paths between devices in one embodiment of the authentication system;

FIG. 9 shows the communication paths between devices in another embodiment of the authentication system;

FIG. 10 shows the communication paths between devices in another embodiment of the authentication system; and

FIG. 11 shows the communication paths between devices in yet another embodiment of the authentication system.

### DETAILED DESCRIPTION

In simplified overview, a computer-implemented system and method are described herein for user authentication or payment in an online transaction with a service provider. A novel mobile-based security mechanism is disclosed that uses biometric authentication technology over Near Field Communication (NFC) between two or more devices. A benefit of this security mechanism is that it frees the service provider's service server and/or the user's host computer from the responsibility of protecting themselves from malicious external attacks. Another benefit is to leverage biometric authentication without storing each user's biometric data in any external servers or databases.

Embodiments of the system and method may be achieved by isolating the authentication process from the service process between the user's host computer and the service provider's service server, and moving the authentication process to one occurring between the user's mobile communication device (e.g., smartphone, tablet, etc.) and a dedicated authentication server.

For example, when a service provider needs to authenticate users, rather than maintaining its own database of registered users, ID's and passwords, prompting users to supply this information to login and then authenticating the user's responses against the stored information, these functions are shifted to an exchange between the user's mobile communication device and a dedicated authentication server. As described herein, to authenticate a user, a service server sends authentication event information to the user's host computer. The user's host computer, in turn, communicates the request to the user's mobile communication device to initiate the authentication process. The mobile communication device then negotiates authentication with a dedicated authentication server by comparing previously acquired and stored authentication data with submitted authentication data. This process preferably also incorporates biometric data into the authentication data via a biometric sensor on the user's mobile communication device.

With the authentication process isolated from the service process, the service server and host computer need not be responsible for security and protecting user Id's, passwords and credit card information from theft. This is because, in the isolated authentication process, this information is stored only on the authentication server or on the user's mobile communication device. Accordingly, the service server does not need to maintain its own database of user authentication data. This allows the service provider to focus solely on providing the best service to its clients without requiring users to install cumbersome security tools on their host computers. Similarly, since the user does not need to enter any authentication data into the host computer, the user does not need to be concerned with making transactions on unsecured or unknown devices, such as a public computer in a library or the like.

With the foregoing overview in mind, specific details will now be presented, bearing in mind that these details are for illustrative purposes only and are not intended to be exclusive.

### Authentication and Payment System

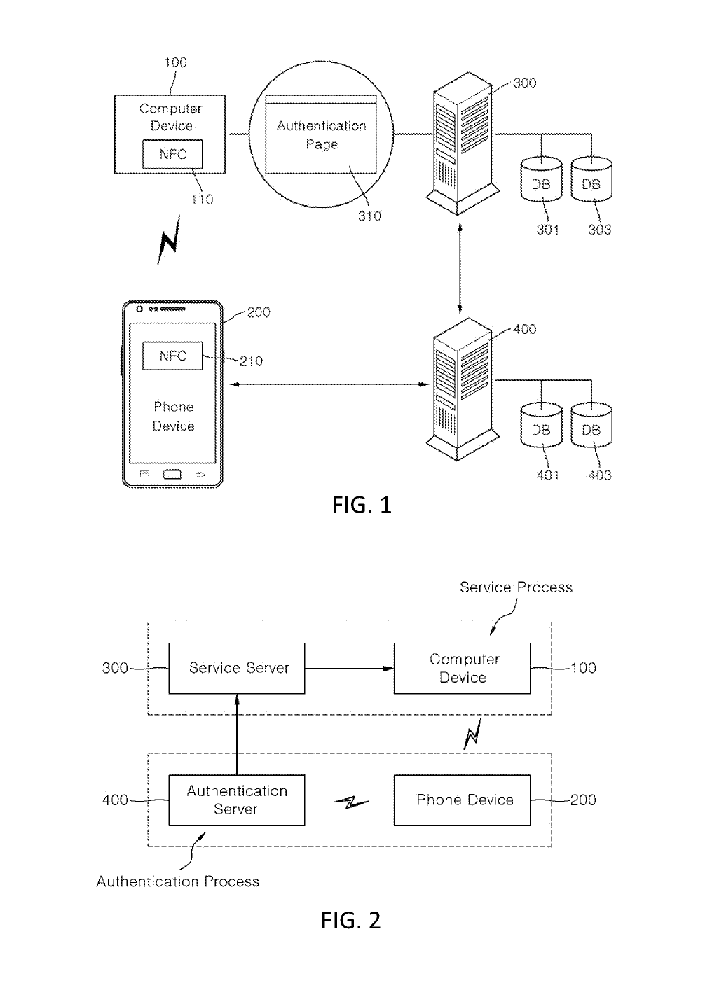

FIG. 1 illustrates, in simplified form, one example arrangement of the authentication and/or payment system described herein. As shown in FIG. 1, the arrangement includes a user host computer device 100, a mobile communication device 200 (e.g., smartphone, tablet, etc.), one or more service servers 300, and one or more authentication servers 400. The user of the host computer 100 uses the service provided by the service server 300, which may be, for example, a web service provided through an internet website 310 or a platform service that particular application software runs and connects to.

The servers and computers 100, 300 and 400 may be any known computing devices, such as (but not limited to) laptop computers, desktop computers, server computers or any other processor-based computing devices. The servers and computer devices 100, 300 and 400 generally include at least one processor connected to memory and networking hardware to perform storage and network communication activities. The servers and computers 100, 300 and 400 can generally be running any known operating system, such as (but not limited to) Windows®, Mac OS® or Linux®. The network interface may be any known interface for communicating over one or more networks, which may be, for example, a wide area network (WAN) such as the Internet, the Public Switched Telephone Network (PSTN), a local area network (LAN), an intranet, an extranet, a cellular network, any wired or wireless network, or any combination of the above.

Host computer 100 will generally also include a user input device (e.g., touch screen, keyboard, mouse, etc.), a user interface (e.g., Windows®, Mac OS® or iOS®), a web browsing interface (e.g., Internet Explorer®, Chrome® or Safari®), and networking interfaces (Wi-Fi, Ethernet and/or NFC 110), as well as readily available software drivers to control the hardware. The networking interface shown in FIG. 1 as NFC unit 110 may be either an internally built-in chip within the host computer 100 or an external module connected to the host computer 100, including by wire such as a USB cable. While it will be understood that any means of mobile communication device to computer communications may be employed for this function (e.g., Bluetooth®, infrared, Wi-Fi, USB), for ease of reference, we will describe the embodiments in the context of NFC.

The host computer 100 thus covers a broad range of possible computing devices. The requirements of a host computer 100 are preferably that: (i) it is capable of connecting to the service server 300 by a communication network, (ii) it should have a NFC unit 110 (either internally or externally), and (iii) when the communicating service server 300 requires authentication, the processor(s) in the host computer should be able to provide the mobile communication device 200 with the service process's ID token (e.g., authentication event information) by using the NFC unit 110.

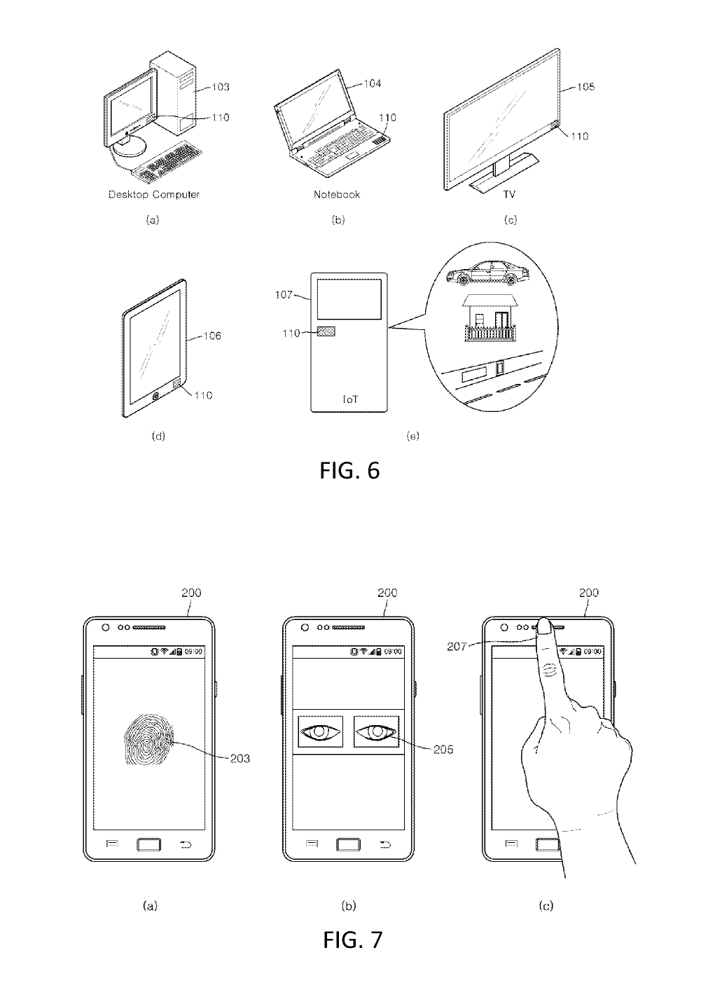

Exemplary embodiments of host computer 100 that may be employed are shown in FIG. 6, including (but not limited to) a desktop computer (FIG. 6a), laptop computer or notebook (FIG. 6b), Smart TV (FIG. 6c), tablet PC (FIG. 6d), and Internet of Things (IoT) device (FIG. 6e). IoT device may be, for example, a built-in device in an automobile, home appliance or electronic devices in public areas such as a subway station.

Service server 300 and authentication server 400 will typically be server computers running server software, such as (but not limited to) Windows® Server, Linux® or OS X® Server. Service server 300 includes known hardware and software necessary for service provisions. For example, service server 300 may be running any known web server software (e.g., Apache™) to provide web services including a website 310. The service server 300 may also include one or more databases 301, 303 used for service provisions (e.g., maintaining website data such as products being sold). The databases 301, 303, however, need not be user authentication databases.

Authentication server 400 includes such known hardware and software necessary for authenticating users. For example, authentication server 400 may be running any variety of known server software (e.g., Windows® Server, OS X® server, Linux® or the like) and include any known and commonly available communication hardware for communicating wirelessly via, for example, a cellular network, Wi-Fi and wired networks.

Authentication server 400 may also include one or more authentication databases 401, 403 for authenticating the user of host computer 100. The authentication database(s) 401, 403 is preferably encrypted and, in some embodiments, may contain user information such as name and a hashed value associated with the user's biometric data. In other embodiments, the authentication database(s) 401, 403 may include the user's personal information such as name, address, credit card information, biometric data, shopping preferences, password, user ID, and the like. Service server 300 and authentication server 400 also include storage for databases 301, 303, 401, 403, which may be internal, external and/or cloud based storage.

The same or different entities may operate the service server 300 and authentication server 400. Where the service provider also operates the authentication server 400, the service server 300 and authentication server 400 are preferably separate from each other (both physically and conceptually).

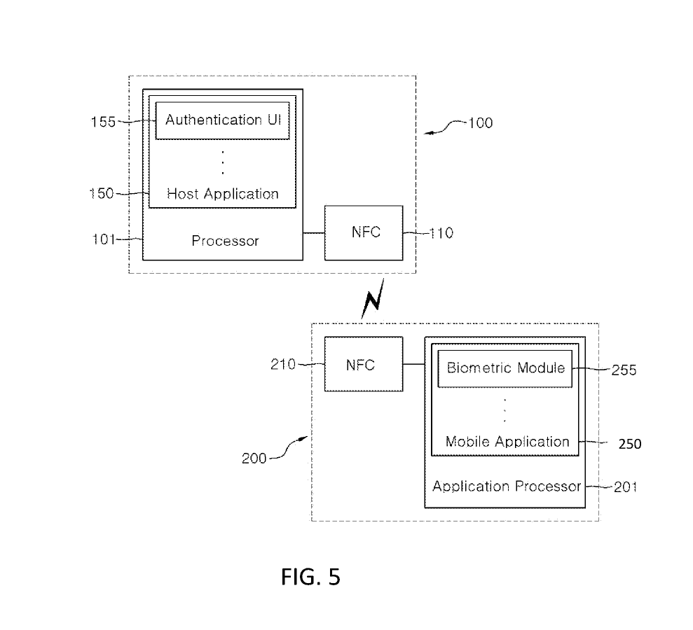

Mobile communication device 200 is preferably a mobile computing device that can be carried with the user so that it is generally available for use in the authentication process. Representative examples of mobile communication devices 200 include (but are not limited to) a smart phone, tablet computer, personal digital assistant (PDA), laptop computer, etc. The mobile communication device 200 includes components such as one or more application processor(s) 201 (FIG. 5), input/output (I/O) devices, memory, battery and power switch. Mobile communication device 200 is also preferably equipped with multiple communication means including (but not limited to) cellular, NFC 210, Bluetooth® and Wi-Fi in order to receive a service process's ID (e.g., authentication event information) from the host computer 100. Mobile communication device 200 also is preferably configured to perform user authentication procedures, and able to communicate with the authentication server 400 via a network. The mobile communication device 200 preferably includes biometric capabilities, such as (but not limited to) a fingerprint, finger vein and/or iris scanner for authenticating users.

Referring to FIG. 5, mobile communication device 200 also preferably includes mobile application software 250 that includes configuration setting tools, a user interface and database components known in all common mobile applications. The most ubiquitous of the mobile communication device having these capabilities today are smartphones, such as (but not limited to) the Apple iPhone® 6, Samsung Galaxy®, HTC One® or LG V10®.

Referring back to FIG. 1, the user of host computer 100, mobile communication device 200, service server 300 and authentication server 400 communicate with each other via one or more networks, which may be, for example, a wide area network (WAN) such as the Internet, the Public Switched Telephone Network (PSTN), a local area network (LAN), an intranet, an extranet, a cellular network, any wired or wireless network, or any combination of the above. Preferably, the host computer 100, service server 300 and authentication server 400 communicate via the Internet, and the mobile communication device 200 communicates with the host computer 100 via near field communications (“NFC”) and with the authentication server via a cellular network. Host computer 100, mobile communication device 200, service server 300 and authentication server 400 may also communicate with each other directly or indirectly via other devices acting as communication nodes.

### Authentication and Payment Process

FIG. 2 is a block diagram illustrating how the system components shown in FIG. 1 may be used in the authentication and payment process. Referring to FIG. 2, there are two example processes shown: (1) the service process that takes place between the host computer 100 and the service server 300; and (2) the authentication process that takes place between the mobile communication device 200 and the authentication server 400. There is also a mechanism between the service process and authentication process to link to and trigger the authentication processes. As explained in further detail below, the system and method described herein physically isolates the authentication process from the service process whereby the advantages described herein may be achieved.

### Service Process

The service process is the process of carrying out a website's or application's primary purpose—for example, selling goods on a website or providing a banking customer access to the customer's account.

The service process occurs when a user uses a host computer 100 to access a service provider's service server 300 and performs online actions, such as requesting particular services or making purchase (e.g., when a user accesses an ecommerce site such as Amazon.com via a web browser on their home computer). In some embodiments, the service provider may be a website 310 that a user accesses through an Internet browser running on the user's host computer 100. In other embodiments, the service can be a platform service where particular applications will run in a specific environment. In these scenarios and others where there is a user accessing a remote computer, typically over an unsecure network such as the Internet, some level of authentication will likely be desired.

In these instances where user authentication is required, the servicer server 300 may initiate a request for user authentication by generating authentication event information and sending the information to the host computer 100. Authentication event information may include a unique identifier for the event such that the service server 300 can later identify the authentication server's 400 success or failure notifications.

### Linking the Service Process to the Authentication Process

Since the service process and authentication process are by design structurally isolated from one another, there is provided a triggering or linking mechanism whereby the authentication event information from the service server 300 triggers the authentication process.

FIG. 5 illustrates the composition and mechanism of this process at the two user-side devices (host computer 100 and mobile communication device 200) where the service process and authentication process get linked. First, the host computer 100 is shown connecting wirelessly with mobile communication device 200. Host computer 100 includes processor(s) 101 for executing program instructions of a host application 150 (e.g., web browser or app) that includes a user authentication interface 155. Host computer device 100 also includes near field communication (NFC) hardware unit 110. In some embodiments, the host application 150 can be either dynamically installed by the user or built-in software in the user's host computer 100. The host application 150 can be represented as a widget or icon on the user's host computer 100 and is capable of connecting to the service server 300 via a communication network. The host application 150 can also receive authentication event information and issue requests for the user to link his mobile communication device 200. While the user authentication interface 155 is shown to be stored in the host computer device 100, it may also be stored in the service server 300 and dynamically downloaded to the user's host computer in real-time.

Mobile communication device 200 preferably includes processor(s) 201 for executing program instruction from a mobile authentication application 250 that interfaces with biometric module 255 and near field communications (NFC) unit 210. Mobile communication device 200 and host computer 100 preferably communicate with each other via NFC units 110 and 210.

Referring to FIG. 5, the triggering mechanism between the service process and the authentication process occurs when user authentication is needed and a user authentication interface 155 is displayed on the screen (display) of the host computer 100. The user authentication interface 155 then starts the authentication event and processor(s) 101 invokes the NFC unit 110 to control NFC communication with the user's mobile communication device 200. The host computer 110 then requests that the user start the authentication process by connecting the user's mobile communication device 200 to the host computer 100 via NFC.

In some embodiments, the mobile communication device 200 may first start its mobile authentication application software 250, and then physically approach the NFC unit 110 of the host computer 100 to initiate NFC communication and receive the authentication event information. In other embodiments, the mobile communication device 200 may first physically approach the NFC unit 110 of the host computer 100, and then the mobile communication device's mobile authentication application 250 is started by the processor(s) 201 as a result of receiving authentication event information from the host computer 100. The authentication event information may be, for example, a dynamic session token negotiated between the host computer 100 and the service server 300 or an ID token that uniquely identifies the particular service process between the service server 300 and the host computer 100.

After the authentication event information is transferred to the mobile communication device 200, the mobile communication device 200 and authentication server 400 start their secure authentication process.

### Authentication Process

The authentication process is an exchange between the mobile communication device 200 and the authentication server 400 that confirms whether the user is the person he purports to be. As discussed above, the authentication process may be triggered when the user's host computer 100 transfers authentication event information to the user's mobile communication device 200.

The authentication process compares a previously stored reference set of data with a current data set entered or generated during the authentication process. The data sets may be (but are not limited to) traditional authentication data such as user ID and password, a unique ID associated with the mobile communication device, and/or biometric data.

In various embodiments, the reference set of authentication data may be stored on either the mobile communication device 200 or the authentication server 400. Likewise, the comparison of the reference set of authentication data and the current set of authentication data may be done on either the authentication server 400, or on the mobile communication device 200 and then communicated to the authentication server 400. As discussed below, the mobile communication device 200 and authentication server 400 may communicate with each other either directly (e.g., via Wi-Fi or cellular communication) or indirectly (e.g., via the host computer 100 and/or service server 300).

Further details of biometric authentication process will be discussed below. In simplified overview, however, the user is preferably authenticated using biometric data either: (1) scanned and hashed on the user's mobile communication device 200, and sent to and verified by the authentication server 400 (Authentication Method 1); (2) scanned and used on the mobile communication device 200 to decrypt authentication data stored on the mobile communication device (Authentication Method 2); or (3) scanned and used on a crypto-processor enhanced mobile communication device 200 to access authentication data stored on the mobile communication device (Authentication Method 3).

The authentication server 400, in turn, notifies the service server 300 as to whether the user has been authenticated. Upon receipt of the authentication results, the service server 300 may also notify the user, such as, for instance, by allowing or denying the requested service.

Further details of three biometric authentication embodiments (Authentication Methods 1, 2 and 3) and two connection pathways (direct and indirect) follow.

### Communication Pathways

Once the user end of the authentication process is complete, the authentication data and authentication event information are sent from the mobile communication device 200 to the authentication server 400 as described above. This data may be sent either directly or indirectly.

In the direct embodiment, referring to FIG. 2, the data pathway between the mobile communication device 200 and the authentication server 400 take place using the mobile communication device's wireless communication module to connect to a wireless communication interface on the authentication server 400.

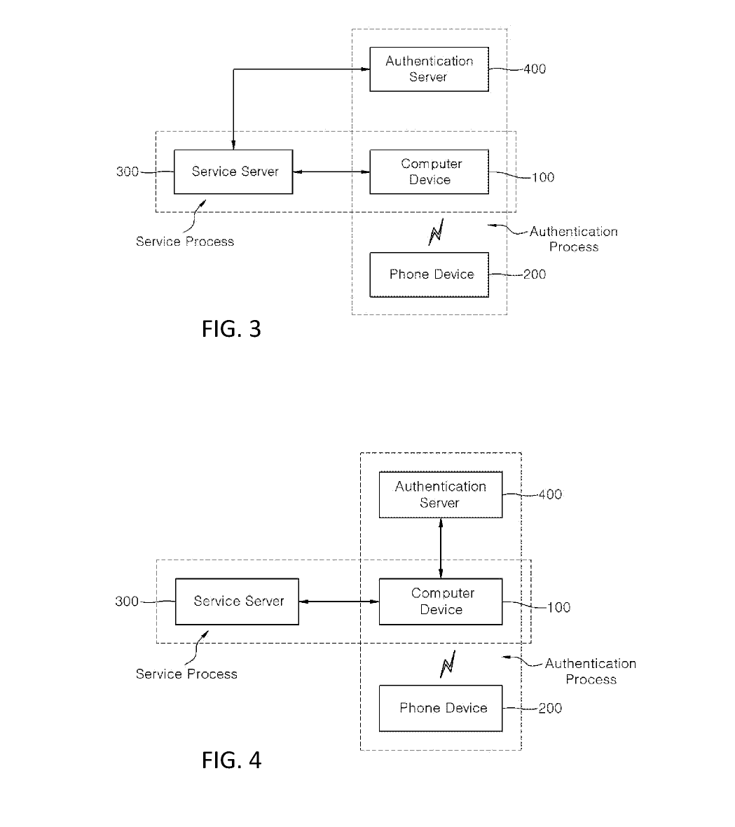

In indirect embodiments, referring to FIGS. 3 and 4, the data pathway between the mobile communication device 200 and the authentication server 400 may take place by leveraging the host computer device 100, and optionally the service server 300, as intermediate relaying nodes. In these cases, the transferred data between the mobile communication device 200 and the authentication server 400 preserves end-to-end encryption for all data packets or sensitive portion of data transferred between them so that intermediate nodes cannot read or tamper with the data. Here, the role of the host computer device 100 and the service server 300 are analogous to the intermediate router nodes that relay data packets but cannot read or tamper with encrypted application-level data packets transferred between two communicating end-point devices. Thus, any compromise of the service server 300 or the host computer device 100 does not compromise the user's authentication data, and the advantages of the separate service processes and authentication processes are maintained.

Referring again to FIG. 2, the direct approach can be used if the mobile communication device 200 can access Wi-Fi or the mobile communication network to directly connect to the authentication server 400. Referring to FIGS. 3 and 4, the indirect approaches can be used at any time, but are particularly advantageous if the mobile communication device 200 cannot use Wi-Fi or the mobile communication network to connect to the authentication server 400.

### Biometric Authentication

It is preferable that biometric authentication be employed to improve the security of the user authentication process. In such embodiments, referring to FIG. 5, the mobile application software 250 preferably supports biometric authentication using biometric data (e.g., comparing a previously stored reference set of data to a currently measured set of data). As illustrated in FIG. 7, a biometric object can be (but is not limited to) one or more of a fingerprint image (FIG. 7a), iris image (FIG. 7b), finger vein scan (FIG. 7c), and/or any other distinct biometric data. The biometric data is preferably a transformation of the original data arising from the biometric scan wherein the scanned data is transformed by hashing it with a user selected secret hash key.

Three alternate biometric authentication embodiments (Authentication Methods 1, 2 and 3) in which the mobile communication device 200 processes the user's biometric data during the authentication process are described below.

### First Biometric Authentication Method

### Authentication Server-Side Comparison of Hash Vectors

The first biometric authentication method is as follows. Briefly, the authentication server 400 maintains one or more databases 401, 403 of previously stored vectors representing each user's ID and biometric data. When authentication is needed, the user uses his mobile communication device 200 to scan the user's biometric object (e.g., fingerprint, iris, finger vein, etc.), transform the biometric object data into a cryptographically hashed value of the biometric data, and sends this hashed biometric data to the authentication server 400. The authentication server 400, in turn, compares the received biometric data values with the biometric data values stored in its database(s) 401, 403 for the particular user ID. Ideally, the biometric data sent to the authentication server 400 during authentication and the previously stored data on authentication server 400 are cryptographically hashed values of the biometric data (e.g., the original scanned biometric data is transformed to a hashed value) rather than using the original scanned data of the biometric object. In this way, if the hashed biometric data is ever intercepted or compromised, it is not feasible to derive a user's original biometric data (e.g., actual fingerprint, iris or finger vein scan) based on the cryptographically hashed values.

In further detail, the authentication server's database(s) 401, 403 stores a set of vectors representing each user's ID and cryptographically hashed values of the user's biometric data. The user ID is used to uniquely identify each user and the user's cryptographically hashed biometric data. These stored hashed values of the user's original biometric data are referred to as the “first feature vector set.” The authentication server 400 can use each user's first feature vector set as a reference to determine whether future biometric authentication attempts succeed or fail. Thus, in order for a user to attempt a biometric authentication, the user must pre-register his biometric feature vector set at the authentication server 400 as the first feature vector set. A hash key is used for hashing the user's biometric data. The hash key can be determined by the user, may be the user's own secret key, and should be kept secret from the authentication server 400.

Once the reference first feature vector set is registered with the authentication server 400 and stored in database(s) 401, 403, the user can subsequently authenticate himself. To do so, the user physically scans his biometric data using his mobile communication device 200, which computes the cryptographically hashed feature values of the user's scanned biometric object data (e.g., the original biometric data) with the user's secret hash key. These hashed values of scanned biometric data are referred to as the “second feature vector set.” The user's mobile communication device 200 then sends the second feature vector set to the authentication server 400.

The authentication server 400 compares the stored first feature vector set for the user to the newly received second feature vector set. If the first and second feature vector sets match within a set or pre-defined tolerance, the authentication server 400 concludes that the authentication was successful. The authentication server preferably allows for non-exact matches of the first and second feature vector sets because each biometric measurement is prone to slight difference as a result of measurement errors, environmental factors and the like, which can create variations in the measurement.

After the mobile communication device 200 has transmitted the second feature vector set, it can erase the user's scanned original biometric data and second feature vector set from its memory. As the information is completely deleted from the mobile communication device 200, potential attackers who subsequently attempt to digitally attack or physically steal the user's mobile communication device 200 cannot retrieve any of the user's biometric information.

### Second Biometric Authentication Method

### Mobile Communication Device-Side Data Encryption

The second biometric authentication method is as follows. Unlike the first biometric authentication method, the user's biometric data or cryptographically hashed values of the biometric data are not stored anywhere—neither in the user's mobile communication device 200 nor in the authentication server 400. Instead, the user's biometric data is used as a cryptographic key to encrypt the user's sensitive data (e.g., authentication data such as credit card information or login credentials) and the encrypted data is stored in the mobile communication device 200.

When the authentication process is initiated and the host computer 100 transfers authentication event information to the mobile communication device 200 by NFC, the user uses his biometric data as the decryption key for the encrypted authentication data stored within the mobile communication device 200. Then, the mobile communication device 200 transfers the decrypted authentication data and the authentication event information to the authentication server 400 by either direct wireless communication link or by leveraging the NFC-linked host computer device 100, and optionally the service server 300, as intermediate data relaying nodes. The decryption process may use known fuzzy extraction algorithms. A more complete discussion of known fuzzy extraction methods can be found, for example, in Fuzzy Extractors: How to Generate Strong Keys from Biometrics and Other Noisy Data, Dodis, et al., SIAM J. Comput. 38(1): 97-139 (2008). Fuzzy extraction algorithms assume that each data's encryption and decryption keys are identical so that only the person who encrypted that data can decrypt it.

By example, the user's private data d is encrypted as e by using his biometric data k as the encryption key and e is stored in the user's mobile communication device 200. When decrypting e to restore d, the user newly scans his biometric data k′ and uses it as the decryption key for e. Using known fuzzy extraction algorithms, if k′ and k are close enough according to a user's pre-defined threshold value, k′ can successfully and accurately decrypt e to d. In order to determine if each decryption is successful or not, the mobile communication device 200 may also store each e with h(d), where h(d) is a cryptographically hashed value of d. Thus, when the mobile communication device 200 decrypts e with k′ and gets d′, if h(d) matches h(d), it can be concluded that the decryption is successful and correct. If h(d) does not match h(d), the decryption failed and is inaccurate. The mobile communication device 200 stores tuples (e, h(d)) for each authentication data instance—thus, even if the mobile communication device's 200 authentication data is digitally leaked or the device itself is physically stolen, the user's authentication data is unexposed and secure.

Using this method, the user can store his private login credentials or credit card numbers within his mobile communication device 200 by encrypting them with his biometric data. When the user logs into the service server 300 or makes an online payment, the user can then scan his biometric data with his mobile communication device 200 to decrypt the required authentication data stored in his mobile communication device 200 and send it to the authentication server 400. In this case, unlike the first biometric authentication method, the user can authenticate to the authentication server 400 without storing his biometric feature vector set in the authentication server 400. The user's scanned biometric data by the mobile communication device 200 is erased from the mobile communication device's memory after being used.

### Third Biometric Authentication Method

### Crypto-Processor Biometric Based Authentication

The third biometric authentication method is as follows. The user's biometric data and his sensitive data (e.g., authentication data such as the user's credit card numbers or login credentials) are stored in a dedicated hardware security module or crypto-processor, which is very secure from various software or hardware attacks. In this case, the mobile communication device 200 has a hardware security module or crypto-processor. The mobile communication device 200 can be configured such that only certain programs in the mobile communication device 200 are allowed to communicate with these modules. Thus, malicious software that later intrudes into the mobile communication device 200 cannot retrieve the user's authentication data stored in the hardware security module.

When the third biometric authentication method is used, the user scans his biometric data by using a biometric scanner program in his mobile communication device 200. This program can either directly communicate with the above hardware security module or send the scanned biometric data to another program that can communicate with the hardware security module. The hardware security module can determine whether the user's scanned biometric data matches the previously stored reference biometric data in the hardware security module. If the two biometric data sets match, the hardware security module sends the user's authentication data to the program. Alternatively, if the program communicating with the hardware security module is secure and trusted, this program may request, from the hardware security module, the user's previously stored reference biometric data and the program can compare it with the user's newly scanned biometric data. If the biometric data sets match, the program requests that the hardware security module send the user's authentication data. Then, the mobile communication device 200 sends the data to the authentication server 400. Thereafter, the mobile communication device 200 erases the user's retrieved authentication data, as well as the user's scanned biometric data from its memory, but the user's authentication data and reference biometric data previously stored in the hardware security module remain intact.

The first and second biometric authentication methods described above use software-implemented cryptographic techniques to protect the user's original biometric data. The third biometric authentication method described above uses a hardware-implemented security module.

### Illustrative Payment and Authorization Implementations

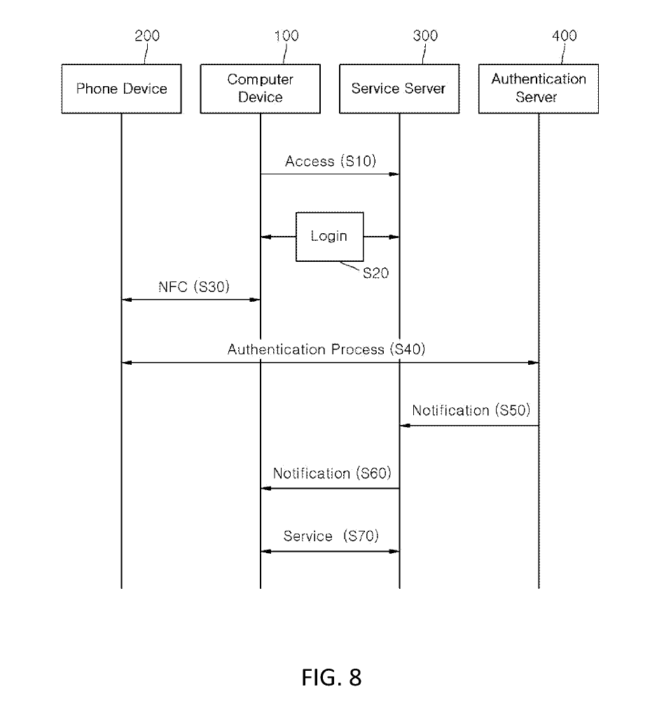

FIGS. 8-11 illustrate various user authentication scenarios leveraging embodiments of the system and method described herein.

### Example of Authentication on Logging into a Service

FIG. 8 illustrates an exemplary procedure of user authentication to log into a service server 300. First, the host computer device 100 connects to the service server 300 (Step S10). For example, the user connects to the service server's 300 Internet site by using a web browser running on the host computer 100.

In this example, the user's host computer 100 may request that the service server 300 allow the user to login by user authentication (Step S20). The user logs in by inputting the user's ID and password on the host computer 100. Alternatively, the user can login by using login credentials previously stored in the host computer device 100. Websites managed by governments or financial organizations may require strong authentication during each user's login. In such case, using only an ID and password is generally insufficient, and using credentials stored in the host computer 100 is vulnerable to malicious attack. These vulnerabilities may be avoided using the systems and method described herein.

Employing the system and methods described above, the host computer's 100 screen may display a “Mobile Authentication” button. When the user clicks or otherwise selects the button, the authentication process event starts. The NFC unit 110 on the host computer 100 may be activated. The user then moves his mobile communication device 200 with NFC chip 210 near the NFC unit 110 of the user's host computer 100, starting NFC communication (Step S30), and beginning the authentication process.

The user's mobile communication device 200 then receives authentication event information via NFC from the host computer device 100, and the mobile communication device 200 and authentication server 400 begin the authentication process (Step S40). As discussed above, the authentication process may proceed under various alternate embodiments that preferably employ biometric authentication.

The first biometric authentication method is as follows. The authentication event information received by the user's mobile communication device 200 from the host computer 100 by NFC may include a session token of the service process. The mobile communication device 200 then scans the biometric data of the user's biometric object, hashes the scanned biometric data, and transfers the hashed biometric data and the authentication event information to the authentication server 400. The mobile communication device 200 may first authenticate the authentication server 400 by verifying the authentication server's digital certificate based on Public Key Infrastructure (PKI).

The authentication server 400 then authenticates the user by comparing the newly received hashed biometric data with the previously stored data for the same user in the authentication server's database(s) 401, 403. The authentication server 400 sends the result of user authentication to the service server 300 (Step S50). It is understood that there can be other entities delivering the authentication server's 400 notification message to the service server 300 depending on the system design. For example, the authentication server 400 can either send notification directly to the service server 300, or send it to the host computer 100, which, in turn, delivers the notification message to the service server 300. In any case, the notification message can be signed by the authentication server 400 to prevent tampering with the authentication result. Meanwhile, the mobile communication device 200 erases the user's scanned biometric data from its memory.

The second biometric authentication method is as follows. The mobile communication device 200 receives the authentication event information from the service server 300 and scans the user's biometric object to obtain the user's biometric data. Then, the mobile communication device 200 uses the scanned biometric data as a decryption key to decrypt the user's previously encrypted authentication data stored in the mobile communication device 200. The mobile communication device 200 uses the decrypted authentication data to authenticate to the authentication server 400. The authentication server 400 receives the user's authentication data and authentication event information from the mobile communication device 200, and then notifies the service server 300 of the user authentication result. Meanwhile, the mobile communication device 200 erases the user's scanned biometric data, decryption key and decrypted user authentication data from its memory.

The third biometric authentication method is as follows. The mobile communication device 200 receives the authentication event information of the service process from the host computer device 100 and scans the user's biometric object to obtain the user's biometric data. Then, a trusted program running on the mobile communication device 200 determines whether the user's scanned biometric data matches the previously stored biometric data in the hardware security module, and if so, the program retrieves the required user authentication data stored in the hardware security module. Then, the mobile communication device 200 transfers the user authentication data and authentication event information to the authentication server 400, which, in turn, notifies the service server 300 of the user authentication result. Meanwhile, the mobile communication device 200 erases the user's scanned biometric data and the retrieved user authentication data from its memory, but the data originally stored in the hardware security module remains intact.

As mentioned in each case above, at the end of biometric authentication, the authentication server 400 notifies the service server 300 of the user authentication result (Step S50). Then, the service server 300 notifies the user via the host computer device 100 by displaying a message of acceptance on the screen or by removing the requested login step that required authentication (Step S60). At this point, the user has successfully logged in. Thereafter, the user uses the services provided by the service server 300 through the host computer 100.

### Example of Reauthorization after Login

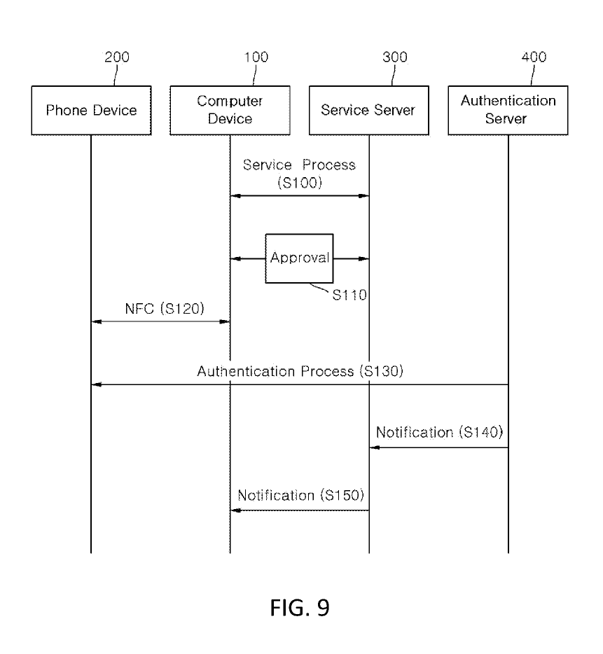

FIG. 9 is an example where the host computer device 100 has been connected to the service server 300 with or without logging in as described in FIG. 8, performs a series of actions, and then carries out actions requiring re-authorization. For example, when the user uses online services from a financial organization or governmental website, after the user logs into the website by user authentication, the user may need to re-authenticate himself before committing certain sensitive actions. For example, the user logs into a bank's website as described in conjunction with FIG. 8, which may allow the user to check balances and take other actions, but when the user takes a more sensitive action such as transferring money to another user's account, the user may be required to perform additional user authentication.

Referring to FIG. 9, the host computer 100 requests a series of services from the service server 300 (Step S100). For example, the user may connect to the service server's 300 Internet website by using the host computer's 100 web browser and request some sensitive service of the service server 300. Examples of such services include (but are not limited to) a wire transfer from a bank website or family certificate issuance from a governmental website.

In order to approve the user's request, the service server 300 requires user authentication (Step S110). Ideally, the user's host computer 100 displays a “mobile authentication” button. The user clicks or otherwise select the button and an authentication event is triggered causing the host computer device's NFC unit 110 to become active and enters a stand-by mode. The user then moves his mobile communication device 200 with NFC chip 210 near the NFC unit 110 of the user's host computer 100, starting NFC communication (Step S120), and beginning the authentication process.

Via the NFC communication, the user's mobile communication device 200 receives the authentication event information from the user's host computer 100. The mobile communication device 200 and authentication server 400 then start an authentication process (Step S130). As discussed above, it is preferable to apply biometric authentication within the authentication process using any of the three biometric authentication processes described above.

After authentication based on one of the three biometric authentication methods either succeeds or fails, the authentication server 400 sends the authentication result to the service server 300 (Step S140). Then, the service server 300 notifies the host computer 100, which displays a notification message on a screen or takes the requested action (Step S150). At this point, the user's originally requested sensitive service (Step S100 in FIG. 9) has been approved and the service server 300 provides this service. For example, the bank server allows the user's wire transfer request, or the governmental organization issues a requested family certificate to the user.

### Example of Secure Mobile Payments

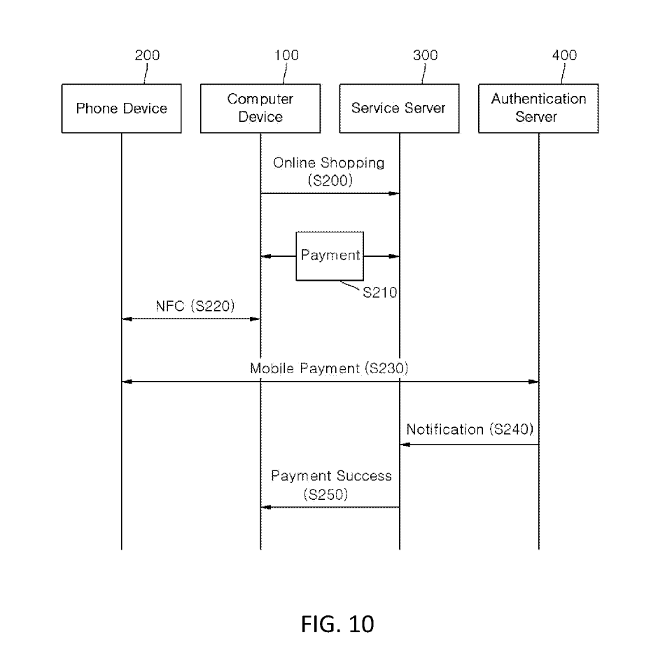

FIG. 10 illustrates an exemplary use leveraging the mechanism of FIG. 9. When a user purchases goods from an online shopping mall or ecommerce site using a host computer 100, the user can make secure mobile payment.

First, there are service activities between the host computer 100 and the service server 300 (Step S200). For instance, the shopping service provided by the service server 300 could be in the form of an Internet shopping mall that the host computer device 100 can connect to using a web browser or using application software installed on the host computer. The user will then, for example, select goods to purchase, proceed to checkout and make payment (Step S210).

The host computer's 100 screen will display a “mobile payment” button as part of the service server's 300 offered services. When the user clicks or otherwise selects the “mobile payment” button, a payment event is triggered. The NFC unit 110 on the host computer 100 is then activated. The user then moves his mobile communication device 200 with NFC chip 210 near the NFC unit 110 of the user's host computer 100, starting NFC communication (Step S220), and beginning the authentication process.

As the mobile communication device 200 receives the mobile authentication event information from the host computer 100, a mobile payment process starts between the mobile communication device 200 and the authentication server 400 (Step S230). As discussed previously, it is preferable to apply biometric authentication within the authentication process using any of the three biometric authentication processes discussed above.

In this example, the biometric authentication process further includes payment information. For example, the user's credit card information may be stored either in the user's mobile communication device 200 or in the authentication server 400. If the biometric-based user authentication succeeds, the user can commit to online payment using previously stored credit card information. In another example, the user can commit a wire transfer upon success in biometric-based user authentication.

After the mobile payment based on one of the above biometric authentication methods either succeeds or fails, the authentication server 400 notifies the result to the service server 300 (Step S240). Then, the service server 300 notifies the host computer 100, which may display notification on the screen (Step S250). At this point, the user's online payment and purchase is complete.

Using this method and system, the user can make online payments by simply clicking the “mobile payment” button on the host computer 100 screen and/or placing the NFC unit 210 of his mobile communication device 200 near the NFC unit 110 of the host computer 100, and biometric authenticating using a finger print or other means on the user's mobile communication device 200. This provides a strong security guarantee and avoids conventional user authentication methods that require the user to have to enter long credit card numbers, expiration dates and security codes, or use their personal OTP device or use user certificates potentially exposed to security breaches. Furthermore, even if the host computer 100 does not belong to the user and is an untrusted device, the user can be reassured that his sensitive authentication data (such as the user's password or credit card information) will not leak and remain secure regardless of the potential compromise or maliciousness of the host computer 100.

### Example of Enhancing Conventional Authentication

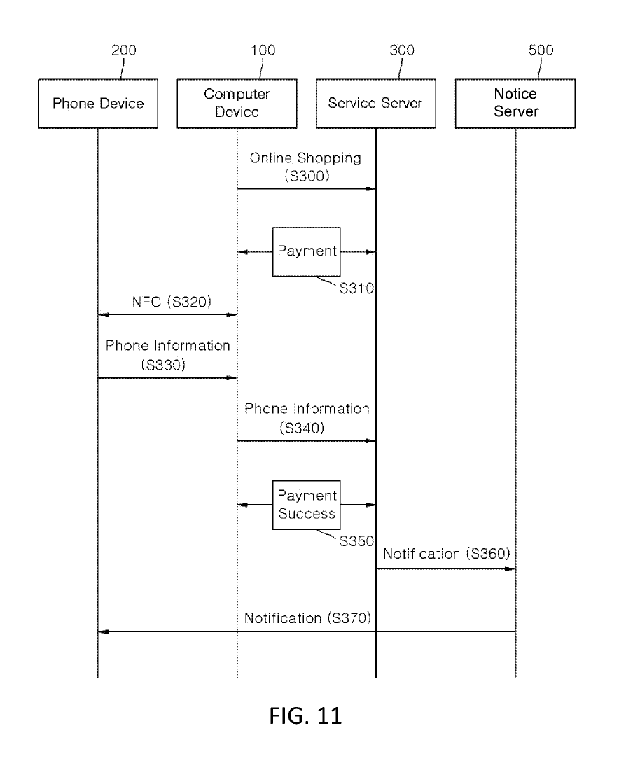

Many new Fintech technologies require changes in existing online payment infrastructure that present considerable hurdles to adoption. FIG. 11 is an example of the application of the present system and method while preserving existing online payment infrastructure.

The existing online shopping malls (Steps S300, S310) can keep their conventional payment-processing infrastructure while adopting the present system and method of authentication between the host computer 100 and service server 300. For example, the host computer 100 can locally store the user's credentials (e.g., User ID, password), and the service server 300 can store the user's credit card information or the user can manually enter his credit card number upon payment, as usual. Step S310 represents the user's payment procedure based on such conventional authentication methods, but after performing these steps, it is also advantageous to add another user authentication stage to verify whether the payment decision has been made by an authorized user.

The conventional method of adding an additional authentication stage generally requires that the user enter his cellphone number into the website. The authentication server 400 verifies the user's phone number and sends a dynamic authentication code to that phone number. The user, in turn, must type the received authentication code into service provider's web page on the host computer device's 100 screen.

Instead, according to the example shown in FIG. 11, the service server 300 provides a payment window for display on the user's host computer's 100 screen that contains a “mobile authentication” button and the user clicks or otherwise selects this button. Then, the NFC unit 110 of the host computer 100 is activated and, as the user's mobile communication device 200 installed with an NFC chip 210 approaches the NFC unit 110 on the host computer, the host computer 100 and mobile communication device 200 start NFC communication (Step S320).

The user's mobile communication device 200 receives authentication event information from the host computer device 100 by NFC. In turn, the mobile communication device 200 sends its device information to the host computer device 100 by NFC (Step S330). This device information is used to uniquely identify the user. For example, this can be the mobile phone number associated with the device 200, optionally coupled with the user's name and/or the user's biometric authentication data.

The mobile communication device 200 sends its device information to the host computer 100 by NFC, which, in turn, sends it to the service server 300 (Step S340). The mobile communication device 200 and service server 300 preserve end-to-end encryption for all data packets or sensitive portions of data transferred between them so that the intermediate host computer 100 cannot read or tamper with their data. The service server 300 can compare the previously registered user information in its database against the newly received mobile communication device information and, if they match, the service server 300 can approve the payment (Step S350).

The service server 300 can request the notification server 500 to send messages to the mobile communication device 200 (Step S360), and then the notification server 500 can send a notification message to the mobile communication device 200 (Step S370). In alternate embodiments, Step S350 can be preceded by Step S370.

The mobile authentication methods and systems described herein can be implemented as a form of executable computer program and can be recorded on various computer storage media. A computer storage medium can contain one or more program commands, data files or/and data structures. The program commands recorded in the computer storage medium can either be specially created and designed for the systems and method or be any of the known programs and code available for general use. Examples of computer storage media can include a hard disk, floppy disk, magnetic media such as a magnetic tape, optical media such as CD-ROM or DVD, magnetic-optical media such as a floptical disk, ROM, RAM and flash memory. These are particular hardware modules that store and help processors execute program commands. Examples of program commands include not only low-level binary machine code created by compilers, but also high-level language code created by interpreters that are executable by computers. A hardware component can be virtualized as one or more software modules while performing actions, and vice versa.

When applying the described method and system, it will be most convenient if the user is registered at both the service server and the authentication server. In this case, the user's ID can be used to uniquely identify the authentication process and service process for each user, and vice versa. However, as far as each user's authentication session is uniquely identifiable, it is not imperative that the user is registered at the service server.

It should be understood that this description (including the figures) is only representative of some illustrative embodiments. For the convenience of the reader, the above description has focused on representative samples of all possible embodiments, and samples that teach the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. A computer-implemented method for authenticating a user of a host computer communicating with a service server over a network, comprising:
receiving, at a mobile communication device including at least one processor and enabled for near field communication (NFC), authentication event information from the host computer via a near field communication link, wherein the authentication event information was generated by the service server and uniquely identifies a particular service process between the service server and host computer; and
transmitting, using at least one processor of the mobile communication device, authentication data associated with the user and the received authentication event information to an authentication server that is physically separate from the service server, wherein the transmitted authentication data and authentication event information permit the authentication server to authenticate the user and notify the service server of the authentication results.

2. The computer-implemented method of claim 1, wherein the transmitting of the authentication data and the authentication event information to the authentication server employs a direct connection via a wireless communication module on the mobile communication device.

3. The computer-implemented method of claim 1, wherein the transmitting of the authentication data and the authentication event information to the authentication server uses the host computer device as an intermediate data relaying node, wherein the mobile communication device and the host computer are linked by near field communications, and all data packets or sensitive portion of data transferred between the mobile communication device and the authentication server preserve end-to-end encryption.

4. The computer-implemented method of claim 3, wherein the transmitting of the authentication data and the authentication event information to the authentication server also uses the service server as an intermediate data relaying node such that all data packets or sensitive portion of data transmitted from the mobile communication device to the authentication server preserve end-to-end encryption.

5. The computer-implemented method of claim 1, wherein the authentication data is stored in memory on the mobile communication device.

6. The computer-implemented method of claim 1, further comprising:
acquiring, using at least one processor of the mobile communication device, biometric data associated with the user via at least one biometric sensor on the mobile communication device.

7. The computer-implemented method of claim 6, wherein the biometric data includes data corresponding to a scan of one or more of a fingerprint, finger vein or iris of the user.

8. The computer-implemented method of claim 6, further comprising:
generating the authentication data, using at least one processor of the mobile communication device, based on the acquired biometric data associated with the user.

9. The computer-implemented method of claim 8, wherein generating the authentication data comprises:
generating, using at least one processor of the mobile communication device, a cryptographically hashed biometric data value of the user's acquired biometric data using a cryptographic hash function; and
transmitting the hashed biometric data value to the authentication server for comparison with a previously stored version of the user's hashed biometric data.

10. The computer-implemented method of claim 6, further comprising:
encrypting, using at least one processor of the mobile communication device, the authentication data using previously acquired biometric data as an encryption key;
storing the encrypted authentication data in memory on the mobile communication device;
decrypting, using at least one processor of the mobile communication device, the stored authentication data using the acquired biometric data as a decryption key; and
transmitting the decrypted authentication data to the authentication server.

11. The computer-implemented method of claim 1, further comprising:
storing, using at least one processor of the mobile communication device, the authentication data and reference biometric data associated with the user in a hardware security module on the mobile communication device;
acquiring, using at least one processor of the mobile communication device, biometric data associated with the user via at least one biometric sensor on the mobile communication device;
comparing, using at least one processor of the mobile communication device, the acquired biometric data to the stored reference biometric data; and
transmitting, using at least one processor of the mobile communication device, the stored authentication data to the authentication server when the acquired biometric data matches the stored biometric data.

12. A tool for authenticating a user of a host computer communicating with a service server over a network, comprising:
a mobile communication device associated with the user, the mobile communication device including at least one processing unit coupled to non-transient memory and enabled for near field communication (NFC); and
an authentication application, stored in non-transient memory, that, when executed by the at least one processing unit, causes the at least one processing unit of the mobile communication device to:
receive authentication event information from the host computer via a near field communication link, wherein the authentication event information was generated by the service server and uniquely identifies a particular service process between the service server and host computer, and
transmit authentication data associated with the user and the received authentication event information to an authentication server that is physically separate from the service server, wherein the transmitted authentication data and authentication event information permit the authentication server to authenticate the user and notify the service server of the authentication results.

13. The authentication tool of claim 12, wherein the transmitting of the authentication data and the authentication event information to the authentication server employs a direct connection via a wireless communication module on the mobile communication device.

14. The authentication tool of claim 12, wherein the transmitting of the authentication data and the authentication event information to the authentication server uses the host computer device as an intermediate data relaying node, wherein the mobile communication device and the host computer are linked by near field communications, and all data packets or sensitive portion of data transferred between the mobile communication device and the authentication server preserve end-to-end encryption.

15. The authentication tool of claim 14, wherein the transmitting of the authentication data and the authentication event information to the authentication server also uses the service server as an intermediate data relaying node such that all data packets or sensitive portion of data transmitted from the mobile communication device to the authentication server preserve end-to-end encryption.

16. The authentication tool of claim 12, wherein the authentication application will further cause the processing unit to:
store the authentication data in non-transient memory on the mobile communication device.

17. The authentication tool of claim 12, further comprising:
at least one biometric sensor configured to receive biometric data from the user.

18. The authentication tool of claim 17, wherein the biometric data comprises at least one of fingerprint data, finger vein data, and iris data.

19. The authentication tool of claim 17, wherein the authentication application will further cause the processing unit to:
generate the authentication data based on received biometric data associated with the user.

20. The authentication tool of claim 19, wherein the authentication application will further cause the processing unit to:
generate a cryptographically hashed biometric data value of the received biometric data using a cryptographic hash function, and
transmit the hashed biometric data value to the authentication server for comparison with a previously stored version of the user's hashed biometric data.

21. The authentication tool of claim 17, wherein the authentication application will further cause the processing unit to:
encrypt the authentication data using previously acquired biometric data as an encryption key,
store the encrypted authentication data in non-transient memory on the mobile communication device,
decrypt the stored authentication data using the received biometric data as a decryption key, and
transmit the decrypted authentication data to the authentication server.

22. The authentication tool of claim 17, further comprising:
a hardware security module on the mobile communication device, wherein the authentication application will further cause the processing unit to:
store authentication data and reference biometric data associated with the user in the hardware security module;
acquire biometric data associated with the user via the at least one biometric sensor on the mobile communication device,
compare the acquired biometric data to the stored reference biometric data, and
transmit the stored authentication data to the authentication server when the acquired biometric data matches the stored biometric data.

23. A computer-implemented online payment method, comprising:
connecting a host computer operated by a user to a service server, wherein a service process between the service server and the host computer includes a request to make an online payment;
receiving, at the host computer, authentication event information generated by the service server and associated with the payment request;
transferring the received authentication event information via near field communication (NFC) from the host computer to a mobile communication device associated with the user; and
transmitting authentication data and the authentication event information from the mobile communication device to an authentication server, wherein the authentication data and authentication event information contain data to permit the authentication server to perform authentication of the user and authorize payment.
